(19) United States
(12) Patent Application Publication
(10) Pub. No.: US 2004/0010388 A1
(43) Pub. Date: Jan. 15, 2004

(54) Method and apparatus for determining proper trace widths for printed circuit board of wireless test fixture

(76) Inventors: Cherif Ahrikencheikh, Loveland, CO (US); Philip N. King, Ft Collins, CO (US)

Correspondence Address: AGILENT TECHNOLOGIES, INC., Legal Department, DL429, Intellectual Property Administration, P.O. Box 7599, Loveland, CO, 80537-0599, US

(21) Appl. No.: 10/192,142

(22) Filed: Jul. 10, 2002

(51) Int. Cl. G06F 19/00

(52) U.S. Cl. 702/121

(57) ABSTRACT

A technique for minimizing the area occupied by traces on wireless fixture printed circuit boards of a printed circuit board tester on a per trace basis which ensures meeting maximum trace resistance and/or proper current delivery requirements for tests to be performed using the traces is presented. A printed circuit board implemented in accordance with the invention includes a plurality of conductive pads and a plurality of traces, each of which conductively connects at least two of said conductive pads. At least two of the traces may have differing respective cross-sectional areas predetermined to allow sufficient current to flow therethrough to drive devices connectable to said conductive pads. The cross-sectional area of each trace is calculated based on the minimum sufficient amount of current required to be delivered across the trace, the maximum allowed resistance of the trace, the trace length, and the characteristic resistance of the trace material.

### FIELD OF THE INVENTION

The present invention pertains generally to testing of printed circuit boards, and more particularly to a technique for minimizing the area occupied by traces on wireless fixture printed circuit boards on a per trace basis while also ensuring proper trace resistance requirements for tests to be performed using the traces.

### BACKGROUND OF THE INVENTION

Printed circuit assemblies (PCA's) must be tested after manufacture. Testing of the bare printed circuit board without components and devices attached is performed to test the continuity of the traces between pads on the board. Loaded-board testing is performed after some or all the electrical components and devices have been attached, and is performed to verify that all required electrical connections have been properly completed. Loaded-board testing is also performed to verify that the loaded components perform within specification.

Printed circuit assemblies testing requires complex tester resources. The tester hardware must be capable of probing conductive pads, vias and traces on the board under test. Loaded-board testing includes analog and digital tests, such as tests for electrical connectivity, voltage, resistance, capacitance, inductance, circuit function, device function, polarity, vector testing, vectorless testing, and circuit functional testing.

FIG. 1 illustrates a test system 1. Test system 1 includes a tester 2, a fixture 3, and a device under test (DUT) mount 25. Tester 2 includes a plurality of test interface pins 9 arranged in an array along the top side of the tester 2. Tester 2 includes tester hardware 5 which operates under the control of a controller 6. Controller 6 may be controlled by tester software 7, which may execute within the tester 2 itself, or remotely via a standard communication interface. One function of the controller 6 is to configure the hardware 5 to make or not make electrical connections between measurement circuits within the tester and each of the test interface pins 9. To this end, each test interface pin 9 is connectable to or isolated from the tester hardware by a relay 4. Electrical contact may be made with a respective test interface pin 9 by closing the relay; conversely, the pin 9 may be isolated from the test hardware by opening the relay 4.

Mounted on top of the tester and over the tester interface pin 9 field is the test fixture 3. Fixture 3 comprises a fixture printed circuit board (PCB) adapter 10 and a fixture frame 20.

The fixture PCB adapter 10 comprises an adapter top plate 11 and an adapter guide plate 13 which together are supported by sidewalls 12. Adapter 10 includes a plurality of solid floating probes 14 that are inserted through precisely aligned holes in the guide/plate 13 and top plate 11. Guide plate 13 ensures precise vertical alignment of solid floating probes 14.

In the embodiment shown, the adapter 10 also includes a probe field shrinking printed circuit board (PCB) 15 which is used to translate the relatively larger test interface pin 9 field of the tester 2 to a relatively smaller probe field of the printed circuit board under test. In particular, in this embodiment, the probe field shrinking PCB 15 comprises a plurality of pins 17 that connect on one end to the top tips of certain test interface pins 9 of the tester and on the other end to conductive traces on the probe field shrinking PCB 15 which route to conductive pads on the top side of the probe field shrinking PCB 15. The adapter includes a plurality of single-ended spring probes 16 whose bottom tips electrically contact the conductive pads on the top side of the probe field shrinking PCB 15. The single-ended spring probes 16 are also inserted through precisely aligned holes in the guide/plate 13 and top plate 11.

The fixture PCB adapter 10 is mounted over the test interface pin 9 field such that the bottom tips of the solid floating probes 14 and the bottom tips of the probe field shrinking PCB pins 17 align with and make electrical contact with the top tips of corresponding test interface pins 9 of the tester 2, as shown.

A fixture printed circuit board (PCB) 8 is mounted on the top plate 11 of the adapter 10 such that the top tips of the solid floating probes 14 and the top tips of the single-ended spring probes 16 align with and make electrical contact with conductive pads on the bottom side of the fixture PCB 8. The conductive pads on the bottom side of the fixture PCB 8 electrically connect to conductive pads on the top side of the fixture PCB 8 by traces and vias, and possibly through several intervening conductive layers of the PCB 8.

The fixture frame 20 includes a top plate 21 and a guide plate 23 supported by sidewalls 22, and an alignment plate 24. Fixture 10 includes a plurality of double-ended spring probes 18 that are inserted through precisely aligned holes in the top plate 21, guide/plate 23 and alignment plate 24. Plastic standoffs 19a and/or retainer screws 19b respectively keep the adapter pins from pushing the fixture PCB 4 up and prevents the fixture PCB 4 from bowing when the assembly is vacuum compressed during test of a PBC under test 26.

Frame 20 is mounted over the fixture adapter 10, precisely aligning the bottom tips of the double-ended spring probes 18 onto conductive pads on the top of the fixture PCB 8 to ensure electrical contact.

The DUT mount 25 includes a support plate 28 mounted on the top side of the frame top plate 21 by foam or spring gaskets 29b. Foam or spring gaskets 29a are also mounted on the top side of the support plate 28 to allow a DUT 26 such as a printed circuit board to be mounted thereon. The printed circuit board 26 may be loaded, including one or more electrical components 27 attached thereto, or may be a bare board.

When a DUT 26 is to be tested, the tester interface pins 9 press on the fixture PCB 8 upward at its bottom conductive pads (indirectly through the fixture adapter 10). Simultaneously, the bottom tips of the double-ended probes 18 press against the fixture PCB 8 downward against its top conductive pads. The top tips of the double-ended probes 18 press against the bottom conductive pads of the DUT 26. During test of the DUT 26, the test software 7 directs the controller 6 to configure the tester hardware 5 to make connections between certain tester interface pins 9 of interest to measurement circuits within the tester hardware 5. The tester hardware 5 may then make measurements of the device or pad under test according to software instruction.

The present invention is concerned with the fixture printed circuit board (PCB) 8. The quality of signals routed on the fixture PCB 8 is affected by probe and pin contact against the conductive pads on opposing sides of the board 8, as well as by the characteristic resistance of the PCB traces.

When making analog measurements, the concern with the traces is in fact the characteristic resistance of each of the traces used in the measurements of the analog components. The effect of the resistance of the trace on the error of the actual measured resistance value of an analog component under test depends on the proportional values of the trace resistance and expected resistance value of the component under test. If the trace resistance is relatively large in proportion to the expected resistance value of the component under test, the measurement error will be large. Conversely, if the trace resistance is relatively small in proportion to the expected resistance value of the component under test, the measurement error will be small. For example, if the trace resistance is 2 Ohms added on to each end of the component under test whose expected resistance value is 10 ohms, the measurement error will be very large in proportion to the actual measured value. If, however, the same trace resistance of 2 Ohms is added on to each end of a component under test whose expected value is 10 KOhms, the measurement error will be insignificant in proportion to the actual measured value.

One solution to the problem of a trace having a high proportional resistance with respect to the expected measured resistance is to increase the cross-sectional area of the trace to ensure sufficient current delivery to the component under test.

In contrast to testing analog components mounted on a printed circuit board under test, which generally are characterized by very low current delivery requirements, when the component under test is a power supply, the current delivery requirements are generally significantly higher (e.g., on the order of 1 to 10 Amps). In this case, the parameter of concern is not generally the trace resistance, but rather the amount of current capability of the trace versus the voltage drop between the measurement circuit and power supply under test. Again, one solution to ensuring sufficient current delivery requirements on the testing trace is to ensure sufficiently large cross-sectional area of the traces testing the power supply.

When testing digital components, the series resistance is the parameter of concern. Generally, a minimum current (e.g., on the order of tenths of an Amp) with a maximum acceptable voltage loss between the measurement circuit and the digital component under test (e.g., on the order of tenths of a Volt) are required to perform the test. These parameters dictate the maximum resistance allowable for traces testing the digital component under test. With digital over-drive testing, the minimum current is much higher (e.g., on the order of 0.75 Amps), but the maximum acceptable voltage loss between the measurement circuit and the digital component under test remains the same. Again, a maximum allowable resistance requirement is thus placed on the testing trace.

In each type of the above-mentioned testing, the trace resistance and/or current delivery requirements of the testing trace may be ensured by using traces of sufficient cross-sectional area. However, increasing the cross-sectional area of the fixture traces increases the area occupied by the traces on the fixture PCB. This in turn can lead to requirements for additional PCB layers, adding cost and complexity to the fixture PCB. Layer count may be reduced by minimizing the area occupied by the traces and their vias.

Accordingly, a need exists for a technique for minimizing the area occupied by traces and vias of a fixture PCB without adversely affecting the quality of the signals thereon.

### SUMMARY OF THE INVENTION

The present invention is a method for automatically minimizing the area occupied by the traces of a test fixture printed circuit board on a per trace basis which ensures proper current delivery requirements for tests to be performed using the traces. A printed circuit board implemented in accordance with the invention includes a plurality of conductive pads and a plurality of traces. Each trace conductively connects at least two conductive pads of the test fixture printed circuit board. At least two of the traces have differing respective cross-sectional areas predetermined to have a maximum trace resistance and/or allow sufficient current to flow therethrough to test devices connectable to the conductive pads. The cross-sectional area of each trace is calculated based on the minimum sufficient amount of current required to be delivered through the trace, the maximum allowed resistance of the trace, the trace length, and the characteristic resistance of the trace material. In particular, in one embodiment, given a fixed trace thickness, the minimum sufficient width of each trace of the fixture PCB is calculated based on the trace resistivity requirements or current delivery requirements of the trace for tests to be performed using the trace. By adaptively applying the minimum sufficient width required for each trace on a per trace basis, tests are guaranteed sufficient current delivery for proper testing performance, while allowing the total trace area to be minimized in order to minimize the PCB layer count and cost. Note that the required width is often a function of trace length.

### BRIEF DESCRIPTION OF THE DRAWING

The invention will be better understood from a reading of the following detailed description taken in conjunction with the drawing in which like reference designators are used to designate like elements, and in which:

FIG. 1 is a block diagram of a printed circuit board test system;

FIG. 2A is a bottom view of a portion of a fixture printed circuit board implemented in accordance with the invention;

FIG. 2B is a top view of the portion of the fixture printed circuit board of FIG. 2A;

FIG. 2C is a transparent top view of the fixture printed circuit board of FIGS. 2A and 2B, illustrating the path of the traces on each conductive layer;

FIG. 3 is a block diagram of a system for calculating the minimum sufficient trace widths for each net in a fixture PCB implemented according to the invention;

FIG. 4 is an operational flowchart illustrating the method of the invention;

FIG. 5A is a block diagram view of a printed circuit board test system implemented in accordance with the invention;

FIG. 5B is a bottom view of a portion of the fixture printed circuit board shown in FIG. 5A implemented in accordance with the invention;

FIG. 5C is a top view of the portion of the fixture printed circuit board of FIG. 5B;

FIG. 5D is a transparent top view of the fixture printed circuit board of FIGS. 5B and 5C, illustrating the path of the traces on each conductive layer;

FIG. 6A is a schematic block diagram of a simple analog test apparatus used to derive the equations for calculating the minimum sufficient trace cross-sectional area for a trace used to perform an analog test;

FIG. 6B is a schematic block diagram of the analog test apparatus of FIG. 6A illustrating the problem of parallel parasitic impedance;

FIG. 6C is a schematic block diagram of the analog test apparatus of FIG. 6A illustrating a guarding technique;

FIG. 7 is a flowchart illustrating a method 120 for calculating the minimum sufficient trace width of a net used to perform an analog test;

FIG. 8A is a portion of an example test specification file illustrating the format of the file;

FIG. 8B is a portion of an example test specification file;

FIG. 8C is a portion of an example output file generated by the minimizing trace calculator of the invention illustrating the format of the file; and

FIG. 8D is a portion of an example output file generated by the minimizing trace calculator of the invention;

FIG. 9A is a view of a portion of the first conductive layer of a printed circuit board implemented in accordance with a second embodiment of the invention;

FIG. 9B is a view of a portion of the second conductive layer of the printed circuit board of FIG. 9A according to the second embodiment of the invention;

FIG. 9C is a view of a portion of the third conductive layer of the printed circuit board of FIGS. 9A and 9B according to the second embodiment of the invention; and

FIG. 9D is a transparent top view of the fixture printed circuit board of FIGS. 9A, 9B and 9C, illustrating the path of the traces on each conductive layer

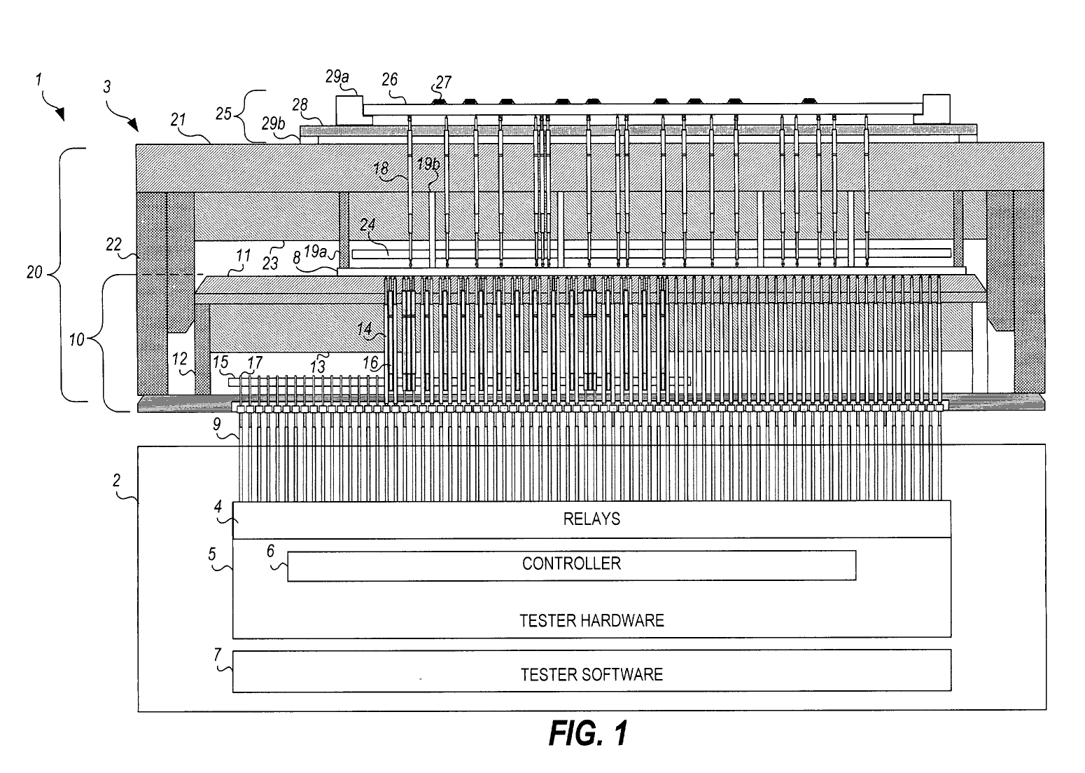

### DETAILED DESCRIPTION

A novel method for automatically minimizing the area occupied by the traces of the fixture PCB on a per trace basis is described in detail hereinafter. Although the invention is described in terms of specific illustrative embodiments, it is to be understood that the embodiments described herein are by way of example only and that the scope of the invention is not intended to be limited thereby.

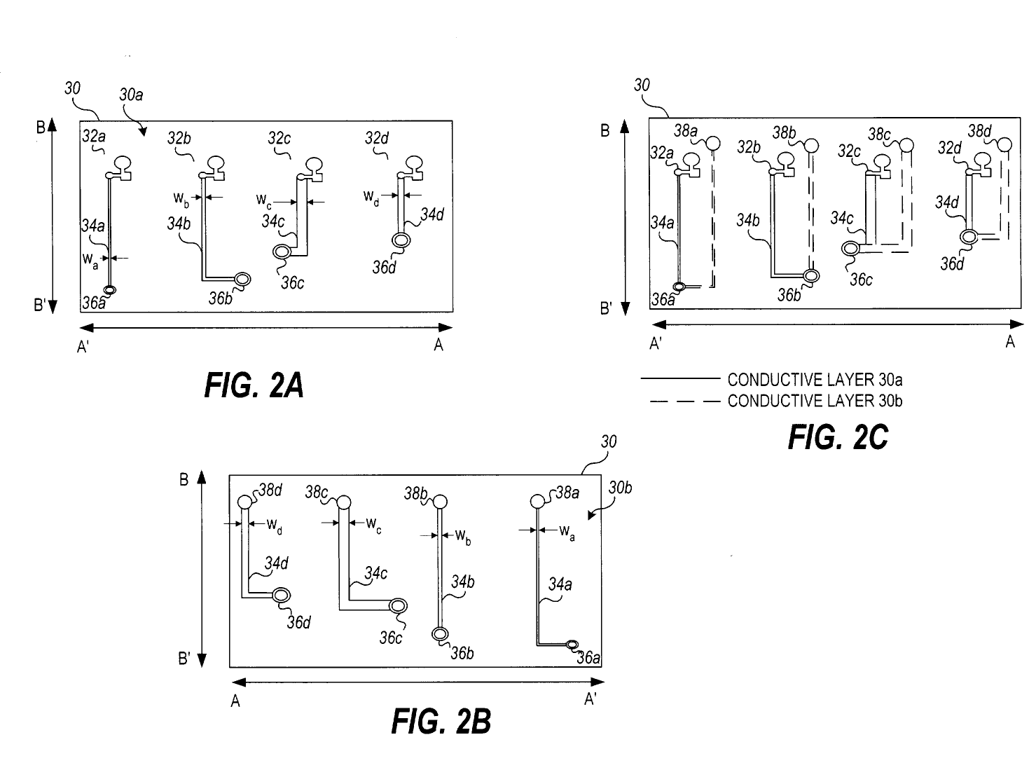

Turning now to the invention, FIGS. 2A, 2B, and 2C illustrate a fixture PCB 30 implemented in accordance with the principles of the invention. As shown therein, the fixture PCB 30 includes a plurality of conductive traces 34a-34d connecting between conductive pads 32a-32d and vias 36a-36d on a first side 30a of the board 30, which connect to conductive pads 38a-38d on the opposite side 30b of the fixture PCB 30. As shown, the traces 34a-34d vary in width wₐ-w_{d} in order to allow the minimum sufficient width of the trace while meeting maximum trace resistance requirements and/or still ensuring sufficient current delivery to support accurate testing.

In particular, FIG. 2A shows the bottom side view of the portion of the PCB 30. In this example, the bottom side 30a of the PCB 30 comprises a conductive pad 32a conductively connected by a conductive trace 34a defined by a first width wₐ to a via 36a. The bottom side 30a of the PCB 30 comprises a conductive pad 32b conductively connected by a conductive trace 34b defined by a second different width w_{b} to a via 36b, a conductive pad 32c conductively connected between a conductive trace 34c defined by a third different width w_{c} to a via 36c, and a conductive pad 32d conductively connected by a conductive trace 34d defined by a fourth different width w_{d} to a via 36d.

FIG. 2B shows the top view of the portion of the PCB 30 of FIG. 2C. In this example, the vias 36a-36d each connect through an intervening dielectric layer of the board 30 to the top 30b of the PCB 30. The top 30b of the PCB 30 therefore comprises conductive via 36a from the bottom 30a of the PCB 30 conductively connected to a conductive pad 38a by the continuation of the conductive trace 34a defined by first width wₐ. The top 30b of the PCB 30 also comprises conductive via 36b from the bottom 30a of the PCB 30 conductively connected to a conductive pad 38b by the continuation of the conductive trace 34b defined by width w_{b}, conductive via 36c from the top side 30a of the PCB 30 conductively connected to a conductive pad 38c by the continuation of the conductive trace 34c defined by width w_{c}, and conductive via 36d from the top side 30a of the PCB 30 conductively connected to a conductive pad 38d by the continuation of the conductive trace 34d defined by width w_{d.}

FIG. 2C is a transparent top view of the PCB 30 of FIGS. 2A and 2B, illustrating the path of the traces on each conductive layer 30a, 30b.

As illustrated, each of conductive traces 34a, 34b, 34c, 34d have different widths wₐ, w_{b}, w_{c}, w_{d}, which are calculated according to the principles of the invention to have a substantially minimum sufficient width to meet maximum trace resistance requirements and/or deliver sufficient current to devices under test for proper performance of tests performed on the devices under test using each trace.

For simplicity, the illustrative example of the fixture PCB 30 of FIGS. 2A, 2B, and 2C assumes only two conductive routing layers (namely, the bottom exposed conductive layer 30a and the top exposed conductive layer 30b. However, it will be appreciated by those skilled in the art that the fixture PCB may include any number of intervening conductive layers through which signals may be routed between the bottom and top exposed layers 30a and 30b.

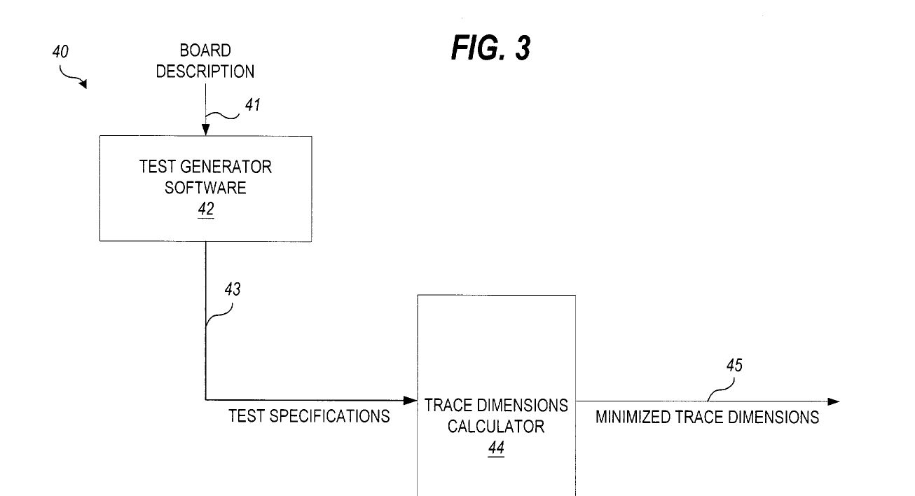

FIG. 3 is a block diagram of a system 40 for determining the minimum sufficient trace width for each net of a fixture PCB on a per net basis. As shown, the system 40 includes test generator software 42 which receives a board description 41 of the physical locations, parameters, and characteristics of each of the devices pads, and nets on the board under test. Given the board description 41, the test generator software 42 determines a set of tests to be executed and a set of nets on the wireless test fixture printed circuit board that will be used to perform the tests, and generates a set of test specifications 43. Among other test setup parameters, the test specifications 43 include the current requirements for performing the test and/or the maximum resistance of each trace used in performing the tests. A trace minimizing calculator 44 calculates the cross-sectional area or width and/or thickness of each trace based on the maximum resistance and/or current delivery requirements of the trace so as to minimize the area that the trace occupies on the printed circuit board. In the illustrative embodiment, the length of the trace is predefined, and the thickness of the trace is fixed; accordingly, the trace minimizing calculator 44 calculates the substantially minimum trace width for each trace that still ensures sufficient current delivery across the trace to perform the tests associated with the net.

In order to determine the minimum sufficient width for a given trace, all of the devices that are stimulated for test by the trace must be considered. These devices may require various types of tests, such as digital-only tests, analog-only tests, or both types of tests, which require different amounts of current. In addition, some digital tests of certain devices require “over-driving” of other devices in their proximity, and hence sufficient current must also be delivered to these other devices.

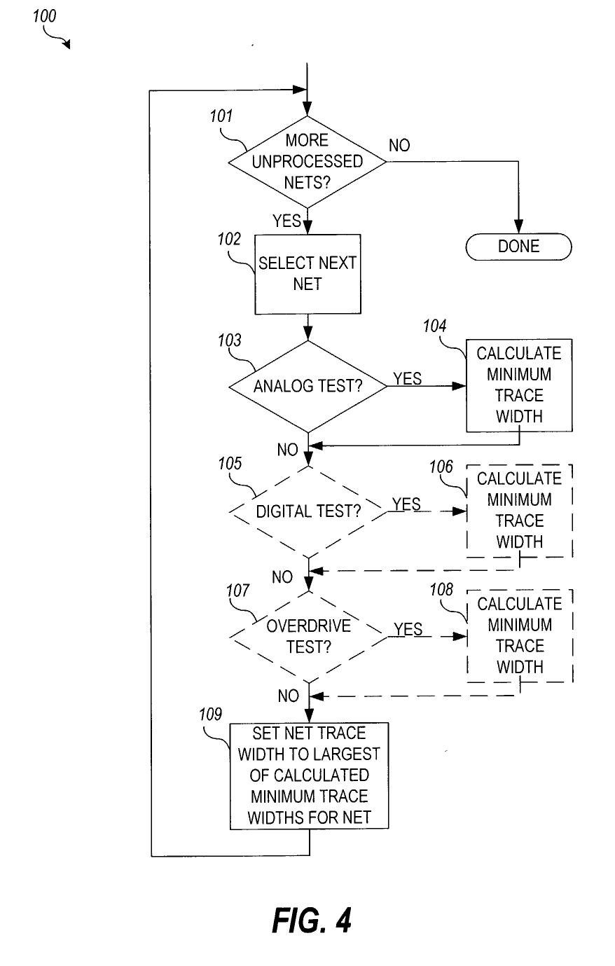

FIG. 4 depicts a method for determining the minimum sufficient trace width for each net of a wireless fixture PCB on a per net basis in accordance with the invention. As shown, for each net on the fixture PCB, the minimum sufficient trace width of the net is calculated for each possible test that will be executed using the trace. The widest of the calculated minimum sufficient trace widths is selected as the trace width in order to ensure sufficient current for each test. In particular, method 100 begins by selecting a first net 101/102. The method determines whether an analog test is to be performed 103, and if so, calculates 104 a minimum trace width required to provide sufficient current on the selected net to perform the analog test. The method then optionally determines whether a digital test is to be performed 105, and if so, calculates 106 a minimum trace width required to provide sufficient current on the selected net to perform the digital test. The method then optionally determines whether an overdrive test is to be performed 107, and if so, calculates 108 a minimum trace width required to provide sufficient current on the selected net to perform the overdrive test. Once all minimum trace widths are calculated for each test to be performed using the trace, the widest of the calculated minimum trace widths for the selected net is selected 109 as the trace width for the selected net. Steps 101-109 are repeated for each remaining unprocessed net.

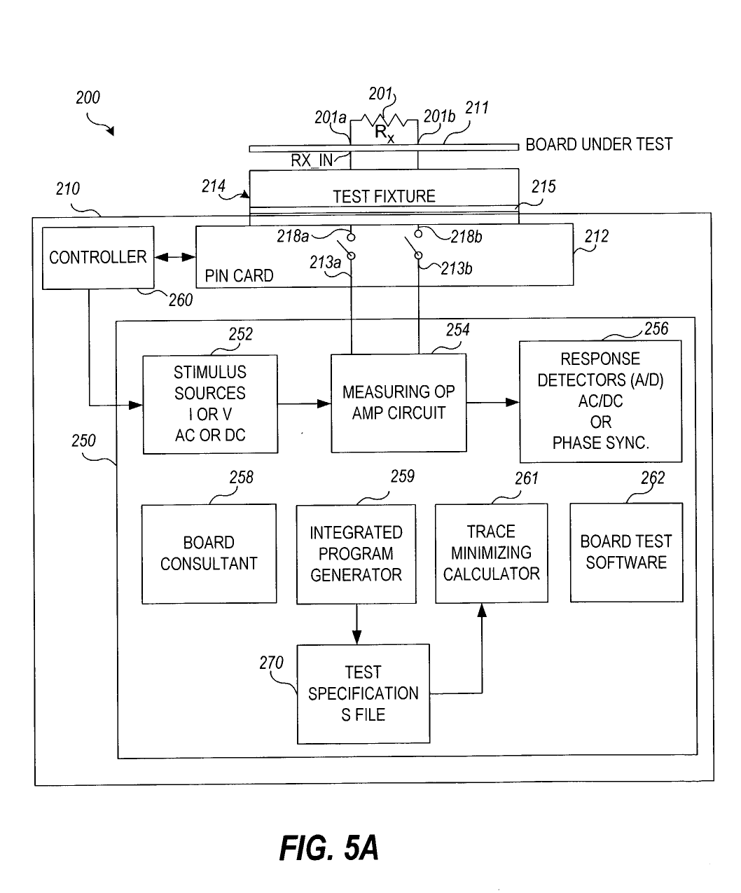

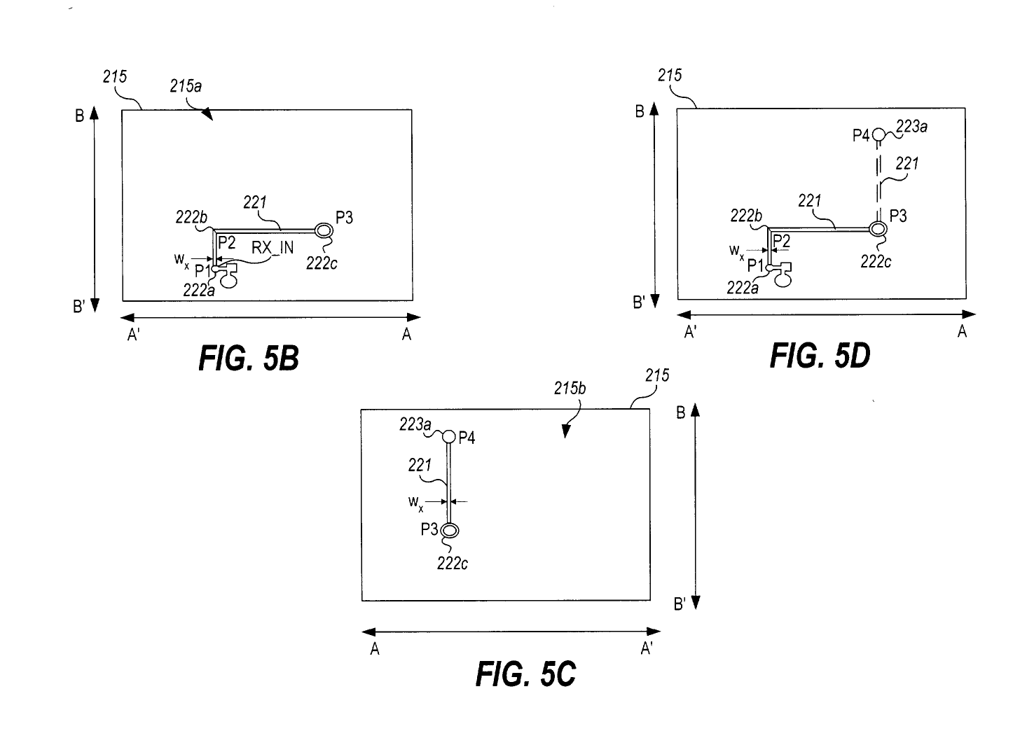

FIG. 5A is a block diagram view of a test system 200 implemented in accordance with the invention. As shown, the test system 200 is set up to be connected to test a resistor 201 on a board under test 211. The board under test 211 is mounted on a test fixture 214, including a fixture printed circuit board 215. The tester hardware includes a pin card 212 and measurement hardware 250 comprising stimulus sources 252, a measuring operational amplifier (MOA) circuit 254, and response detectors 256. A controller 260 manages each in-circuit test by closing the proper testhead relays 213a, 213b to connect the device under test 201 to the MOA circuit 254. The measurement hardware 250 includes a stimulus source 252, which may be configured to connect a current source, voltage source, AC or DC source as the source input to the MOA circuit 254. The measurement hardware 250 also includes a response detector circuit 256 which may be configured to detect analog or digital signals. As the stimulus source 252 is applied to the MOA circuit 254, the response detector 256 measures the output of the MOA circuit 254 and sends the results to the controller 260 for evaluation. Depending on the results, the controller 260 sends either a pass or fail condition back to the test program.

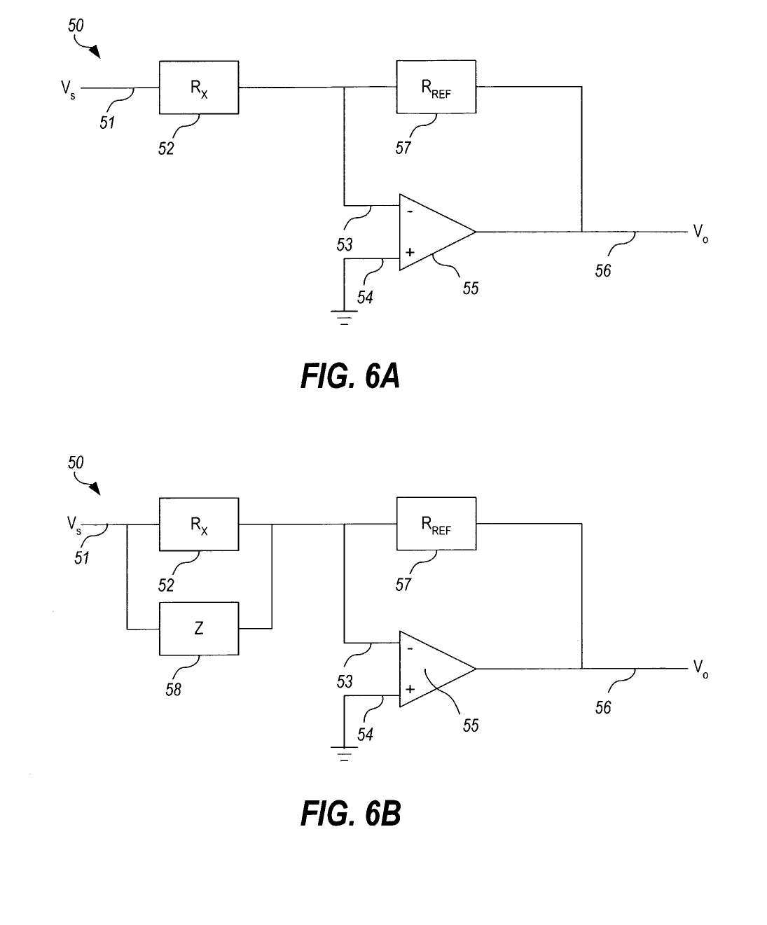

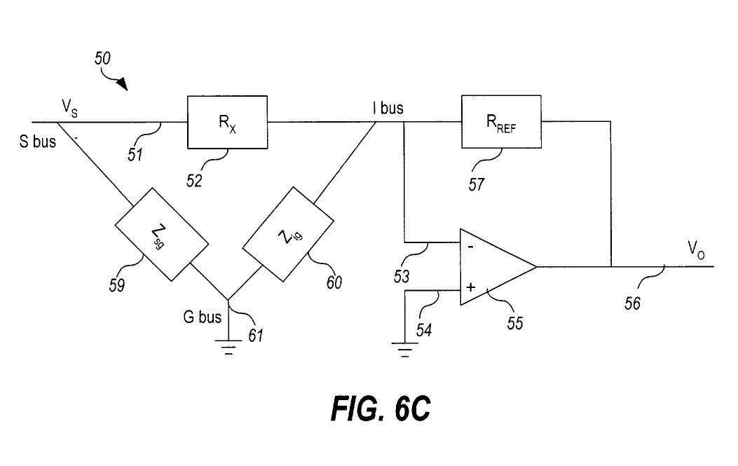

FIG. 6A is a schematic block diagram of a simple analog test apparatus 50 implementing the MOA circuit 254 of the measurement hardware 250. The analog test apparatus 50 determines the resistance value R_{X} of the tested analog device 52 (e.g., resistor, capacitor, inductor, diode, transistor, fuse, potentiometer, etc.) by using a reference device 57 having a known resistance value R_{REF} and measured source and detector voltages V_{S} 51 and V_{O} 56. As illustrated, the analog test apparatus 50 includes an operational amplifier 55 having a positive input 54 connected to a circuit ground, a negative input 53 connected between the output of the device under test 52 and one end of a known reference feedback resistance R_{REF} 57, and an output V_{O} taken on an output line 56 and connected to the second end of the known feedback resistance R_{REF} 57.

Because the input impedance of an operational amplifier 55 is characteristically very high, most of the current flowing through the device under test will flow through the reference resistance R_{REF} 57. The resistance value R_{X} of the device under test may therefore be calculated as:

R_{X}=R_{REF}*V_{S}/−V_{O} (Formula 1)

In practice, the device under test 52 may have one or more parallel paths around it depending on the board's circuit topology. In these situations, the impedance of these parallel parasitic paths can cause errors since they are not included in the above formula. FIG. 6B is a schematic block diagram of the simple analog test apparatus 50 illustrating the parasitic resistance problem. As shown, a parallel parasitic resistance path Z 58 is in parallel with the device under test 52.

The problem shown in FIG. 6B is circumvented using a technique called “guarding”. An analog test apparatus which illustrates the guarding technique is shown in FIG. 6C. In this apparatus, the parallel impedance path is broken by a guard bus G 61. By connecting the G bus 61 as shown, the current that would otherwise flow through both Z_{sg} and Z_{ig} becomes negligible. When the non-inverting input 54 to the operational amplifier 55 is grounded as shown in FIG. 5C, the inverting input 53 becomes a virtual ground due to characteristics of the operational amplifier 55. This also places the I bus connection 53 at virtual ground. With the G bus 61 also at ground potential, no difference of potential exists across Z_{ig,} and no current flows through the parallel path around R_{X} and through the feedback path R_{REF}. The applied voltage V_{S} on line 51 does supply current to Z_{sg}; however, this current does not affect the measurement as long as the output impedance of the applied voltage V_{S} is very low compared to Z_{sg}. Also, because there may be one or more parallel paths around the device under test 52, there may be one or more G bus connections. Accordingly, as long as the above conditions are met, essentially the same current flows through R_{X} and R_{REF}, allowing formula (1) to apply once again.

In practice, the value R_{X} of the device under test 52 is allowed to deviate from a nominal value within a tolerance range. The board test software 262 (see FIG. 5A) returns a “PASS” status for the device under test 52 if the value R_{X} calculated using formula (1) is within these tolerances, and a “FAIL” status is returned otherwise. Accordingly, the current delivered to test the device must handle device values within the entire tolerance range, or must be high enough (greater than some minimum value) to handle the highest allowable impedance. In addition, since some of this current will be lost to flow through the parasitic path portion Z_{sg}, the required stimulus current must be higher to account for this loss.

In turn, the traces through which the required current is delivered must be thick enough to accommodate its required minimum value. Hence, given the maximum allowable impedance value R_{X}=R_{MAX} of the device under test 52 and the impedance Z_{sg} of the parasitic path, the minimum required current iₘᵢₙ is given by:

iₘᵢₙ=V_{S}/R_{MAX}+V_{S}/Z_{sg} (Formula 2).

The resistance of the trace R_{TRACE} is based on:

1. For an analog test, the allowable test error budget (as analyzed by the tester software, e.g., IPG 259 of FIG. 5A) as it relates to I_{MIN}, involves (more or less) an allowable voltage drop in the circuit divided by R_{TRACE}. The allowable error impedance calculated by the tester analysis software leads directly to a maximum value for R_{TRACE}.

2. For a digital/overdrive test R_{TRACE} comes from the allowable voltage drop for the device/family type and the device's normal operating voltage levels combined with the worst case expected current.

3. For power traces R_{TRACE} can be calculated based on the actual expected power supply current for the DUT board, or the maximum current the system power supply can deliver. This current combined with the acceptable power supply voltage drop leads to a maximum value for R_{TRACE}.

The resistance of a conductor with length (L), cross-sectional area (A) and bulk resistivity (p) is given by:

$$R = \frac{ρ L}{A} \qquad ( Formula 3 )$$

which leads to:

$$A = \frac{ρ L}{R} . \qquad ( Formula 4 )$$

Applying this to a specific printed circuit board construction we can work in terms of squares (trace segments with equal length and width) to simplify the calculations. For example the total resistance R_{TRACE} of a 1-oz copper trace having a per-square resistance of 0.49 mOhms/square is equivalent to the following number of squares:

n_{squares}=R_{TRACE}/0.00049 (Formula 5)

If this trace has length l, its corresponding width is:

w=l/n_{squares} (Formula 6)

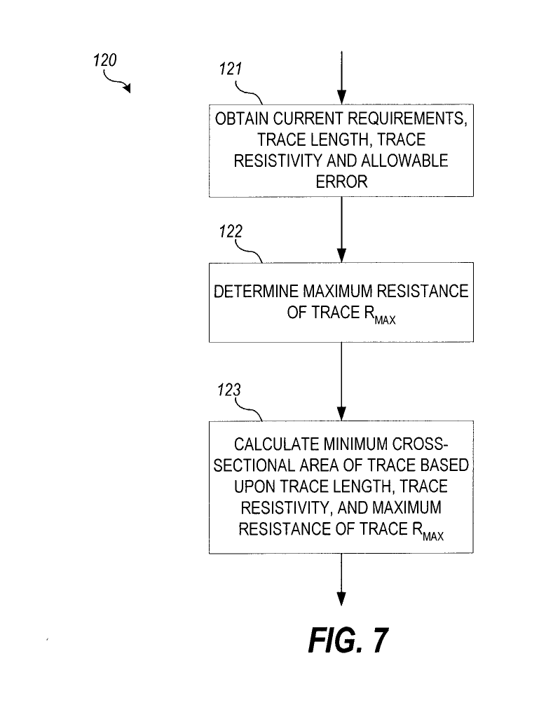

FIG. 7 is a flowchart illustrating a method 120 for calculating the minimum sufficient trace width of a net used to perform an analog test. As illustrated therein, the method includes a first step 121 of obtaining the current requirements, trace length, trace resistivity, and allowable error budget of the trace. These parameters may be calculated based on other known parameters, or may be simply be known given values. The method 120 includes the second step 122 of determining the maximum resistance R_{MAX} of the trace. Again, the maximum resistance R_{MAX} may be calculated based on the current requirements, trace length, trace resistivity, and allowable error budget obtained in step 121, or may be simply be a known given value. The method 120 includes the third step of calculating the minimum cross-sectional area of trace based upon trace length, trace resistivity, and maximum resistance of trace R_{MAX}. If the thickness is a known fixed value, the calculation may be reduced to finding the minimum sufficient width of the trace.

Digital tests typically necessitate a minimum current of 0.1A to be delivered through the trace. The acceptable voltage loss (drop) between the tester and DUT is usually on the order of 0.2 V. This means that the maximum resistance of the trace is:

R_{TRACE}=0.2/0.1=2 Ohms (Formula 7)

Using Formula 5 for a 1-oz copper trace having a per-square resistance of 0.49 mOhms/square:

n_{squares}=2/0.00049=4082 (Formula 8)

If the trace has a length/=20″, formula 6 results in a width of:

w=20/4082=0.0049 inches (Formula 9)

These numbers are used for illustration only. Those skilled in the art will appreciate that the results will depend upon the actual values of the current requirements for the test(s), the applied voltage, the trace resistivity, and the trace length.

For digital over-drive tests, over-driving requires a larger amount of current to be delivered than in regular digital tests, for example, a typical value may be 0.75 A. The acceptable voltage loss (drop) between the tester and DUT is usually on the order of 0.2 V. This means that the maximum resistance of the trace is:

R_{TRACE}=0.2/0.75=0.267 Ohms (Formula 10)

Using formula 5 for a 1-oz copper trace having a per-square resistance of 0.49 mOhms/square:

nsquares=0.267/0.00049=545 (Formula 11)

If the trace has a length l=20″, formula 6 results in a width of:

w=20/545=0.0367 inches (Formula 12)

Again, these numbers are used for illustration only. Those skilled in the art will appreciate that the results will depend upon the actual values of the current requirements for the test(s), the applied voltage, the trace resistivity, and the trace length.

Turning back to FIG. 5A, in the preferred embodiment, the tester 210 is an Agilent 3070 running tester software called Board Consultant 258 for setting up a board description of a board under test 201, Integrated Program Generator (IPG) 259 for determining the appropriate tests to be run for each device and generating the tests, the trace minimizing calculator 261 of the invention, and various board tests 262 generated by IPG 259. It will be appreciated that any of the software modules may be executed by a tester processor or alternatively on a remote computer system which communicates with the tester 210 as necessary using standard communication protocols.

FIGS. 5B, 5C, and 5D illustrate a portion of an example PCB 215 used for testing a board under test 211. The portion shown is the portion of the PCB 215 implementing trace 221 for testing resistor R_{X} 201 on the board under test 211 of FIG. 5A. As illustrated in FIGS. 5B, 5C, and 5D, net 221 comprises the metal trace connecting conductive pad 222a to via 222c on the bottom side 215a of the PCB 215 and via 222c to conductive pad 223a on the top side 215b of the PCB 215. The trace width to be determined is shown as wₓ.

In the example of FIGS. 5B, 5C, and 5D, the position of certain tester interface pins 218 correspond to the positions of the bottom conductive pad 222a, trace corner 222b, via 222c, and top conductive pad 223a. For convenience, labels P1, P2, P3, and P4 identify the locations of the bottom conductive pad 222a, the trace corner 222b, via 222c, and the top conductive pad 223a respectively. The x and y coordinates of the locations identified by labels P1, P2, P3, and P4 are known by the tester software (e.g., IPG 259 of FIG. 5A). Accordingly, the location data of the points P1, P2, P3, P4 may be used by the trace minimizing calculator 262 to calculate the length of the trace 221 under consideration. For example, the length of trace 221 is the distance between P1 and P2 plus the distance between P2 and P3 plus the distance between P3 and P4.

Referring again to FIG. 5A, during actual testing of the resistor R_{X} 201, only the pin 218a located at position P1 at the far end of the trace 221 (See FIGS. 5B-5D) is actually electrically connected to the conductive pad 222a on the bottom side 215a of the PCB 215. This is accomplished by closing the relay 213a (FIG. 5A) associated with the tester pin 218a located at position P1. The far end of the trace 221 at position P4 is electrically connected to the first end of the resistor R_{X} 201a. Accordingly, trace 221 forms the line 51 in the operational amplifier circuit of FIG. 6C.

It will be appreciated that the second end of the resistor 201b is connected to the I bus input 53 of the operational amplifier 55 of FIG. 6C using a different trace (not shown).

Prior to test, the integrated program generator IPG 259 (FIG. 5A) generates a test specification file 270 containing tests for each trace, including the maximum resistance for the trace. The parameters in this file may be used to calculate the minimum trace width or cross-sectional area for a given trace.

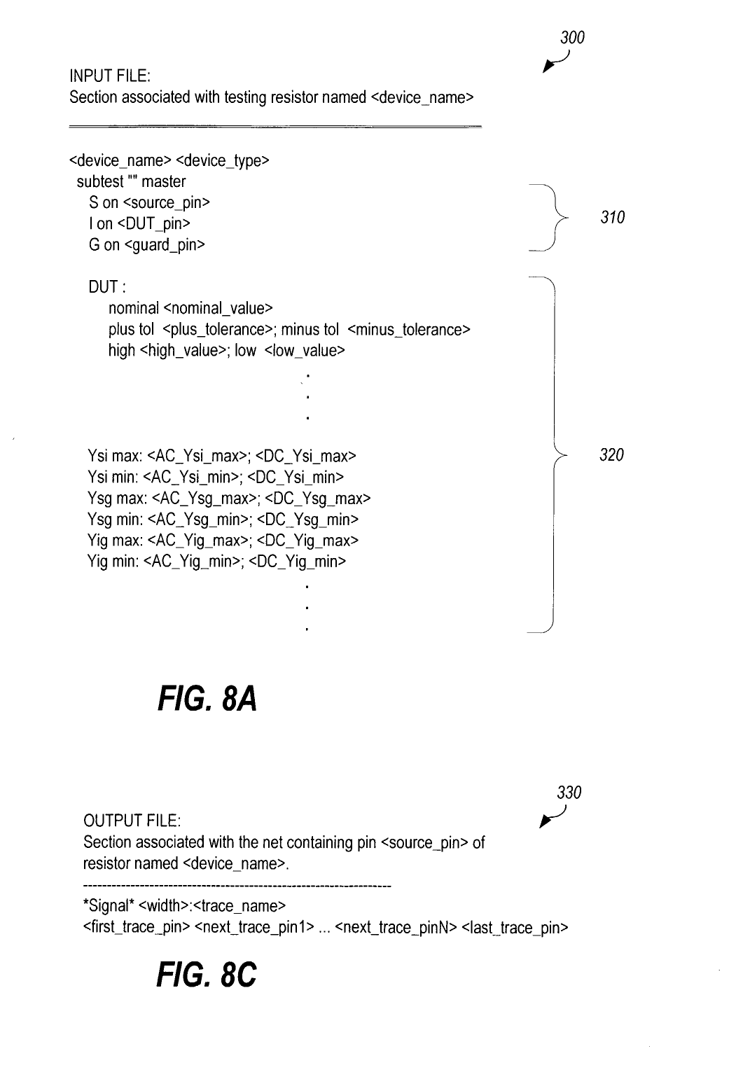

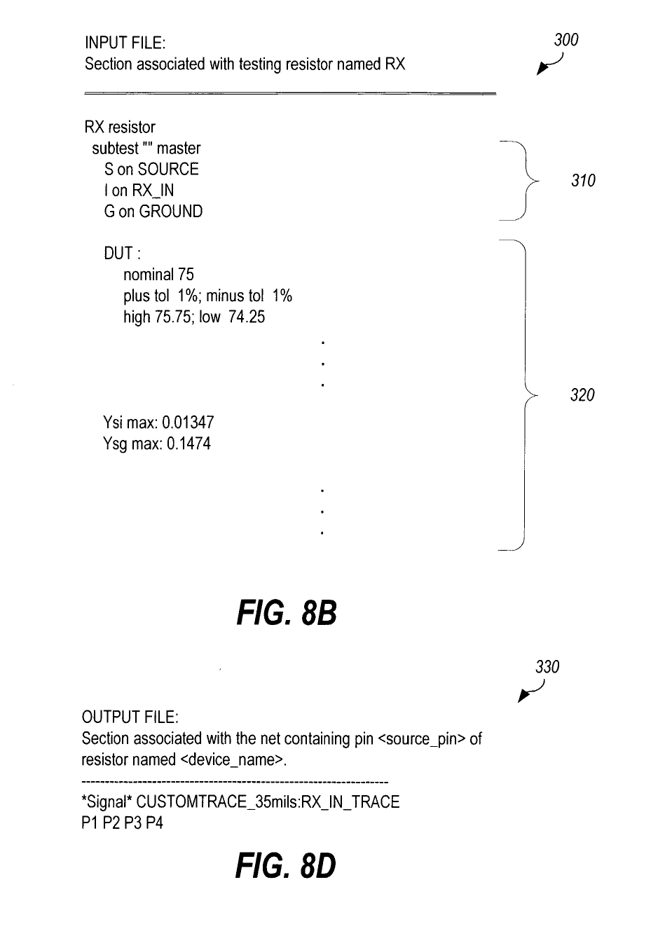

FIG. 8A illustrates the format of a portion 300 of an example test specification file 270 generated by IPG 259. As illustrated, to test a device, net or pad on the board under test 211, IPG 259 generates a test statement containing a connection statement 310 and a measurement statement 320. The connection statement 310 identifies the conductive pads on the bottom of the test fixture printed circuit board 215 that should be probed by the tester interface pins 218, and causes the tester 210 to close/open the appropriate relays 213 (which make/do not make electrical connection between the tester interface pins 218 and the MOA 254 in the tester). The connection statement 310 also specifies the connections to make for each of the S bus 51, I bus 53, G bus 61, and non-inverting input 54 of the operational amplifier 55 in the MOA circuit 50 (FIG. 6C) implementing the MOA circuit 254 of the tester 210.

The measurement statement 320 defines the device name, device type, expected measured value, tolerance, test limits, measurement options, and MOA circuit parameters such as the minimum and maximum admittance Yₛᵢ, Y_{sg}, and Y_{ig} of the device and parasitic parallel path impedances.

FIG. 8B illustrates the portion 300 of an example test specification file 270 associated with testing the resistor R_{X} 201 of FIG. 5A. As shown, in this example the connection statement 310 specifies connecting the S bus to a source voltage SOURCE, the I bus to node RX_IN defined to be at position P1 on the fixture PCB 215, and the G bus to ground.

The measurement statement 320 specifies the nominal value of the resistor R_{X} to be 75 Ohms with a tolerance of +/−1%. For this example the test system analysis software has determined that the maximum acceptable trace resistance (R_{TRACE}) for the S bus connection is 0.12 Ohms. Assuming that the trace is a 1-oz copper trace having a per-square resistance of 0.49 mOhms/square, and that the trace minimizing calculator 262 determines the length/of the trace connecting P1 to P2, P2 to P3, and P3 to P4 to be 8.6 inches, formula (5) may be applied to determine the number of squares as:

n_{squares}=R_{TRACE}/0.00049=0.12/0.00049=245

In this example, since the trace length/is 8.6 inches, then applying formula (6), the width of the trace should be:

w=l/n_{squares}=8.6/245=0.035 inches.

FIG. 8C illustrates the format of an example portion 330 of an output file generated 330 by the trace minimizing calculator 261. As illustrated, the output file specifies a trace width <trace_width> to be associated with a trace <trace_name>. The trace route is defined by PCB positions <first-trace_pin>, <next_trace_pin1>, . . . <next_trace_pinN>, and <last_trace_pin>.

FIG. 8D illustrates the example portion 300 of the output file generated by the trace minimizing calculator 261 based on the input file 300 of FIG. 8B. The portion of the output file shown is a section of the file associated with the trace RX_IN_TRACE connecting to the first end 201a of resistor RX 201 on the board under test 211. As shown, in this example, the output file contains the trace definition “CUSTOMTRACE_{—}35 mils” assigned to the trace named “RX_IN_TRACE”. CUSTOMTRACE_{—}35 mils is determined by the software to be 0.035 inches (or 35 mils) wide. The PCB locations of the trace are indicated as P1, P2, P3, and P4.

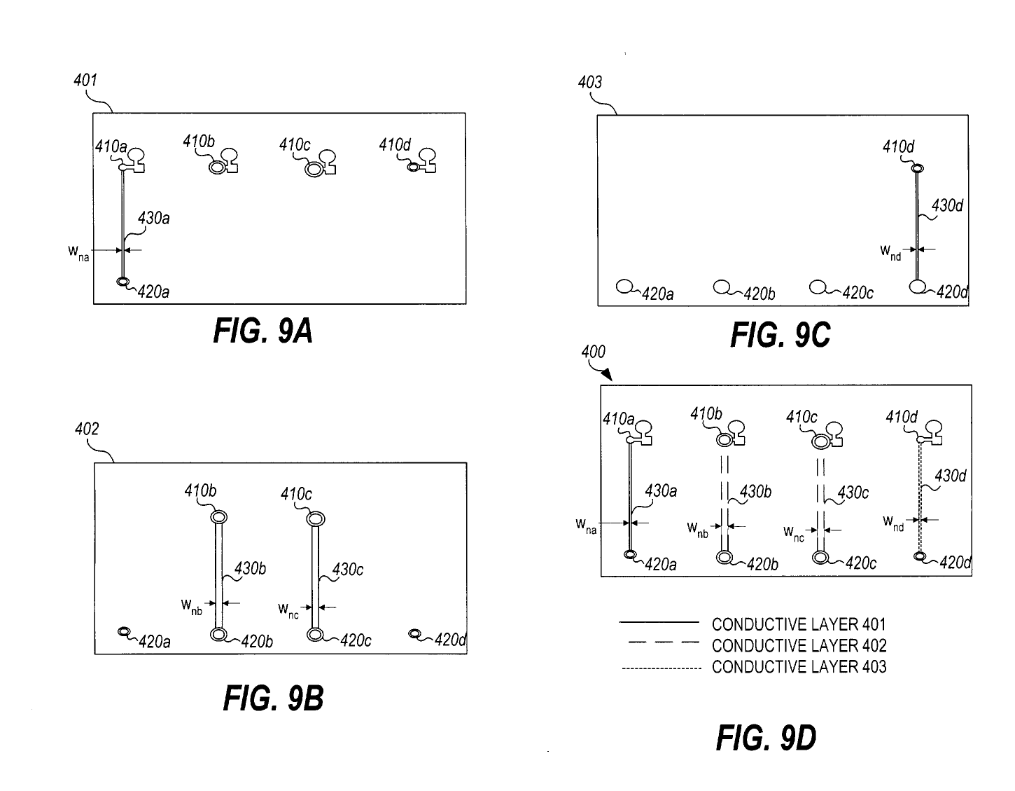

FIGS. 9A-9D illustrate another embodiment of a fixture printed circuit board 400 implemented in accordance with the principles of the invention. In this embodiment, traces 430a, 430d of a first thickness are implemented on layers 401 and 403, where traces 430b, 430c characterized by a second thickness greater than the first are implemented on layer 402. Traces 430b, 430c which require a lower resistance are preferably implemented on layer 402, while traces allowing higher resistance 430a, 430d are implemented on layers 401 and 403.

The above-described invention improves over the prior art in several ways. First, the cross-sectional area of each trace is determined on a per trace basis to ensure that current delivery requirements are met. Second, the cross-sectional area of each trace is preferably minimized to a substantially minimum cross-sectional area that still meets the current delivery requirements of each trace. By minimizing the cross-sectional area of each trace on a per trace basis, the size and number of layers of the fixture printed circuit board are reduced.

While illustrative and presently preferred embodiments of the invention have been described in detail herein, it is to be understood that the inventive concepts may be otherwise variously embodied and employed and that the appended claims are intended to be construed to include such variations except insofar as limited by the prior art.

What is claimed is:

1. A printed circuit board for a test fixture of a printed circuit assembly tester, comprising:
a first trace characterized by a first trace cross-sectional area, said first trace connecting a first conductive pad on a first side of said printed circuit board to a first conductive pad on an opposite side of said printed circuit board;
a second trace characterized by a second trace cross-sectional area, said second trace connecting a second conductive pad on said first side of said printed circuit board to a second conductive pad on said opposite side of said printed circuit board;
wherein said first trace cross-sectional area is different than said second trace cross-sectional area.

2. A printed circuit board in accordance with claim 1, wherein:
said first trace is characterized by a fixed trace thickness and a first trace width; and
said second trace is characterized by said fixed trace thickness and a second trace width;
wherein said first trace width is different from said second trace width.

3. A printed circuit board in accordance with claim 1, wherein:
said first trace is implemented on a first printed circuit board layer; and
said second trace is implemented on a second printed circuit board layer.

4. A printed circuit board in accordance with claim 1, wherein:
said first trace is characterized by a first resistance less than or equal to a first maximum allowable resistance associated with said first trace; and
said second trace is characterized by a second resistance less than or equal to a second maximum allowable resistance associated with said second trace, wherein said second resistance is different than said first resistance.

5. A printed circuit board in accordance with claim 4, wherein:
said first cross-sectional area is a substantially minimum cross-sectional area that characterizes said first trace with said first maximum allowable resistance; and
said second cross-sectional area is a substantially minimum cross-sectional area that characterizes said second trace with said second maximum allowable resistance.

6. A printed circuit board in accordance with claim 1, wherein:
said first cross-sectional area is a substantially minimum cross-sectional area that allows sufficient current delivery to a first node of a board under test mounted on said test fixture when said printed circuit board tester is electrically connected to said first conductive pad on said first side of said printed circuit board and said first node is electrically connected to said first conductive pad on said opposite side of said printed circuit board; and
said second cross-sectional area is a substantially minimum cross-sectional area that allows sufficient current delivery to a second node of said board under test mounted on said test fixture when said printed circuit board tester is electrically connected to said second conductive pad on said first side of said printed circuit board and said second node is electrically connected to said second conductive pad on said opposite side of said printed circuit board.

7. A printed circuit board in accordance with claim 1, wherein:
said printed circuit board is a bare board having no electrical devices or components loaded thereon.

8. A printed circuit board in accordance with claim 1, wherein:
said printed circuit board is a loaded board having at least one electrical device or component loaded thereon.

9. A printed circuit board, comprising:
a plurality of conductive pads; and
a plurality of traces, each of which conductively connects at least two of said conductive pads, wherein at least two of said traces each have a differing respective cross-sectional area predetermined to meet a maximum trace resistance requirement associated with said trace and/or to allow sufficient current to flow therethrough to test devices connectable to said conductive pads.

10. A printed circuit board in accordance with claim 9, wherein:
said at least two traces having differing respective cross-sectional areas are characterized by identical trace thicknesses but differing trace widths.

11. A printed circuit board in accordance with claim 9, wherein:
said printed circuit board is a bare board having no electrical devices or components loaded thereon.

12. A printed circuit board in accordance with claim 10, wherein:
said printed circuit board is a loaded board having at least one electrical device or component loaded thereon.

13. A method for determining a substantially minimum sufficient trace cross-sectional area for each trace of a printed circuit board on a per trace basis, comprising:
selecting an unprocessed trace;
obtaining a minimum sufficient amount of current that said selected trace must deliver and/or a maximum trace resistance by which said selected trace is characterized;
obtaining a routing length of said selected trace; and
calculating a cross-sectional area of said trace based on said routing length and said minimum sufficient amount of current and/or maximum trace resistance.

14. A method in accordance with claim 13, wherein said calculating step comprises:
calculating a substantially minimum sufficient cross-sectional area of said trace to deliver said minimum sufficient amount of current and/or maximum trace resistance.

15. A method in accordance with claim 13, comprising:
obtaining a thickness of said selected trace; and
calculating a trace width of said trace based on said minimum sufficient amount of current and/or maximum trace resistance, said routing length, and said trace thickness.

16. A method in accordance with claim 15, wherein said calculating step comprises:
calculating a substantially minimum sufficient trace width to deliver said minimum sufficient amount of current and/or maximum trace resistance.

17. A computer readable storage medium tangibly embodying program instructions implementing a method for determining a substantially minimum sufficient trace cross-sectional area for each trace of a printed circuit board on a per trace basis, comprising:
selecting an unprocessed trace;
obtaining a minimum sufficient amount of current that said selected trace must deliver and/or a maximum trace resistance by which said selected trace is characterized;
obtaining a routing length of said selected trace; and
calculating a cross-sectional area of said trace based on said routing length and said minimum sufficient amount of current and/or maximum trace resistance.

18. A computer readable storage medium in accordance with claim 17, wherein said calculating step comprises:
calculating a substantially minimum sufficient cross-sectional area of said trace to deliver said minimum sufficient amount of current and/or maximum trace resistance.

19. A computer readable storage medium in accordance with claim 17, said method comprising:
obtaining a thickness of said selected trace; and
calculating a trace width of said trace based on said minimum sufficient amount of current and/or maximum trace resistance, said routing length, and said trace thickness.

20. A computer readable storage medium in accordance with claim 19, wherein said calculating step comprises:
calculating a substantially minimum sufficient trace width to deliver said minimum sufficient amount of current and/or maximum trace resistance.
